(19) United States
(12) Patent Application Publication
(10) Pub. No.: US 2015/0035974 A1
(43) Pub. Date: Feb. 5, 2015

(54) COMBINED IMAGER AND RANGE FINDER

(71) Applicant: RAFAEL ADVANCED DEFENSE SYSTEMS LTD., Haifa (IL)

(72) Inventors: Dov Lavi, Haifa (IL); Ezra Shamay, Qiryat Bialik (IL)

(21) Appl. No.: 14/370,491

(22) PCT Filed: Dec. 27, 2012
(86) PCT No.: PCT/IB2012/057744

§ 371 Date: Jul. 3, 2014

(30) Foreign Application Priority Data
Jan. 4, 2012 (IL) 217361
Jun. 14, 2012 (IL) 220439

(51) Int. Cl. G01S 17/93; G01S 17/08; H04N 5/225; G01S 17/89

(52) U.S. Cl. CPC G01S 17/933; G01S 17/89; G01S 17/08; H04N 5/2256
USPC 348/142

(57) ABSTRACT

combined imager and rangefinder includes an imaging sensor and an illuminator. The sensor acquires images of objects in a FOV. The illuminator directs a beam of light via the FOV. In a first mode, the sensor acquires full images of the whole FOV. In a second mode, the sensor acquires partial images, of only part of the FOV, that include a reflection of the light from one of the objects. The range to the object is determined from the location of the reflection in the partial images. Successive range measurements are used to determine whether a collision with the object is imminent.

### FIELD AND BACKGROUND OF THE INVENTION

The present invention relates to rangefinders and, more particularly, to a device that performs both imaging and rangefinding.

Such devices are known in the prior art. For example, Solomon et al., U.S. Pat. No. 7,342,648, teach a device that includes four lasers that surround a camera and that emit laser beams parallel to the optical axis of the camera. FIG. 1, that is adapted from FIG. 3 of U.S. Pat. No. 7,342,648, illustrates the principle of the operation of the device. The camera images a reflection, from the wall, of a light beam that is emitted by the first laser, at an angle of θ₁, and images a reflection, from the wall, of a light beam that is emitted by the second laser, at an angle of θ₂. Given the parallax d of the lasers relative to the optical axis of the camera, calculating the ranges r₁ and r₂ to the wall is a matter of simple trigonometry.

Typically, the camera of the device of U.S. Pat. No. 7,342,648 is a video camera with a frame rate of 30 to 50 Hz. The controller of the device needs to locate, in the frames, the pixels that correspond to the reflections of the laser beams and then calculate the corresponding angles θ₁ and θ₂ and the corresponding ranges r₁ and r₂. The 30 to 50 Hz frame rate corresponds to a determination of the ranges r₁ and r₂ at most 15 to 25 times per second because the reflections of the laser beams are located in the frames by acquiring two successive frames, one with the lasers on and the other with the lasers off, and subtracting one frame from the other. There are applications in which the ranges need to be calculated faster than 15 to 25 times per second. For example, a drone reconnaissance helicopter could use the device of U.S. Pat. No. 7,342,648 for imaging targets below itself at high resolution while determining its altitude relative to those targets in order to ensure that it remains at a safe altitude above those targets, except that in some cases determining the altitude above the target must be done more often than 25 times per second if the drone descends below a safe altitude above its targets.

Mounting a rangefinder in tandem with the device of U.S. Pat. No. 7,342,648 might not be an acceptable solution if the drone helicopter is small and the added rangefinder would add excessive weight to the drone helicopter and would occupy valuable space in the drone helicopter that would be better used for some other purpose. In principle, the device of U.S. Pat. No. 7,342,648 could be modified to use a video camera with a faster frame rate and to use a faster processor in its controller, but it would be highly advantageous to be able to modify the device of U.S. Pat. No. 7,342,648 to determine ranges faster than 25 times per second without incurring the expense of a faster processor.

### SUMMARY OF THE INVENTION

According to the present invention there is provided a combined imager and rangefinder including: (a) an imaging sensor for acquiring images of objects in a field of view; (b) an illuminator for directing a beam of light at least in part via the field of view; and (c) a controller for: (i) operating the imaging sensor and the illuminator in: (A) a first mode in which the imaging sensor acquires full images that span substantially all of the field of view, and (B) a second mode in which the imaging sensor acquires partial images that span only a portion of the field of view that includes a reflection of the light from one of the objects, and (ii) determining, from a location, in each of at least a portion of the partial images, of a part of the each partial image that images the reflection, a corresponding range to the one object.

According to the present invention there is provided a method of anticipating a collision between a first body and a second body, including the steps of: (a) equipping the first body with an imaging sensor that has a field of view; (b) acquiring, using the imaging sensor, successive partial images that span only a portion, of the field of view, that includes at least a portion of the second body while directing a beam of light at the at least portion of the second body; (c) computing a plurality of first ranges, from the first body to the second body, based at least in part on respective locations within each of a plurality of the partial images, of a part of the each partial image that images a reflection of the light from the at least portion of the second body; and (d) deciding, based on the first ranges, whether a collision between the first and second bodies is imminent.

A basic combined imager and rangefinder of the present invention includes an imaging sensor, an illuminator, and a controller. The imaging sensor, which typically is a video camera or a forward-looking infrared (FLIR) camera, is for acquiring images of objects in its field of view. The illuminator directs a beam of light at least in part via the field of view. The light could be visible, infrared or ultraviolet light but typically is infrared light. The controller operates the imaging sensor and the illuminator in one of two modes. In the first mode, the imaging sensor acquires full images that span substantially all of the field of view. In the second mode, the imaging sensor acquires partial images that span only a portion of the field of view that includes a reflection of the illuminator's light from one of the objects in the field of view. The controller determines, from the location, in each of at least a portion of the partial images, of a part of the partial image that images the reflection, a corresponding range to that object.

Preferably, the imaging sensor acquires the full images at a first frame rate and acquires the partial image at a second frame rate that is faster than the first frame rate.

Preferably, the controller also determines, from at least two of the locations, a rate of approach to the object whose reflections are the subject of the partial images.

Preferably, the illuminator is deployed in a fixed spatial relationship to the imaging sensor. In some preferred embodiments the illuminator directs its beam of light substantially parallel to the optical axis of the imaging sensor. In other preferred embodiments, the illuminator directs its beam of light obliquely relative to the optical axis of the imaging sensor.

In some preferred embodiments, the illuminator uses a source of coherent radiation, such as a laser, to produce its beam of light. In other preferred embodiments, the illuminator uses a source of incoherent light, such as a light-emitting diode (LED), together with collimating optics, to produce its beam of light.

Preferably, in the first mode of operation, the controller determines, from a location, in each of at least some of the full images, of a part of the full image that images the reflection, a corresponding range to an object in the field of view of the imaging sensor. If that range is less than a predetermined threshold, then the controller switches to the second mode of operation and the reflections from that object become the subject of the partial images.

Preferably, the imaging sensor includes a notch filter whose notch passes a range of wavelengths of the light from the illuminator.

Preferably, the imaging sensor includes an array of a plurality of photodetector elements. More preferably, the array is a rectangular array that includes a plurality of rows of the photodetector elements and the partial images are acquired using only a portion of the rows. Most preferably, the illuminator is deployed in a fixed spatial relationship to the imaging sensor so as to direct the light beam only into a portion of the field of view in which reflections of the light from the illuminator are imaged by that portion of the rows. Also most preferably, for each partial image subsequent to the first partial image, the portion of the rows that is used to acquire the new partial image is selected in accordance with the part, of the portion of the rows that was used to acquire the preceding partial image, that images the reflection.

Also most preferably, the imaging sensor includes two or more subpluralities of the photodetector elements. The photodetector elements of each subplurality are sensitive to only a respective range of wavelengths. The partial images are acquired using only some or all of the photodetector elements of just one of the subpluralities. For example, in one of the preferred embodiments discussed below, a Bayer filter is used to render the photodetector elements sensitive to either just blue light or to just green light or to just red and some infrared light, and the partial images are acquired using just some of the rows of only the photodetector elements that are sensitive to just red and some infrared light.

Also most preferably, the photodetector elements are active pixel sensors such as complementary metal-oxide semiconductor (CMOS) sensors.

Preferably, the part of each partial image that images the reflection includes a plurality of pixels, and the location of the part of the partial image that images the reflection is the centroid of those pixels.

The scope of the present invention also includes a vehicle, such as a helicopter, that includes the combined imager and range finder of the present invention.

A basic method of the present invention is a method of anticipating a collision between a first body and a second body. For example, in the preferred embodiments discussed below, the first body is a drone helicopter and the second body is the terrain over which the drone helicopter flies. The first body is equipped with an imaging sensor. The imaging sensor acquires successive partial images that span only a portion of the imaging sensor's field of view that includes at least part of the second body. At the same time, a beam of light is directed at the at least part of the second body. Two or more first ranges from the first body to the second body are computed, based at least in part on respective locations, in the partial images, of parts of the partial images that image reflections of the light from the illuminated at least portion of the second body. Based on the computed first ranges, for example based on the values and rates of change of the first ranges, it is decided whether a collision between the two bodies is imminent. Preferably, if a collision is imminent, the first body is secured to minimize the damage that the collision will cause to the first body.

Preferably, before the partial images are acquired, a second range from the first body to the second body is determined. The acquiring of the first images is initiated if the second range is below a predetermined threshold. More preferably, the determining of the second range includes using the imaging sensor to acquire successive full images that span substantially the whole field of view while directing the beam of light at least in part via the field of view in a manner that is synchronized with the acquiring of the full images so as to support computation of the second range. The computation of the second range is based at least in part on the location in one of the full images of a part of that full image that images a reflection of the light from the second body. Most preferably, the full images are acquired at a frame rate that is slower than the frame rate at which the partial images are acquired.

Also most preferably, during the acquiring of the full images, the beam of light is directed only intermittently, i.e., less often than every other frame, via the field of view of the imaging sensor. In other words, the second distance is not computed for every pair of full images.

Preferably, the directing of the beam of light at the at least portion of the second body is synchronized with the acquiring of the partial images, as opposed to, e.g., continuously illuminating the at least portion of the second body.

### BRIEF DESCRIPTION OF THE DRAWINGS

Various embodiments are herein described, by way of example only, with reference to the accompanying drawings, wherein:

FIG. 1 illustrates the operation of the prior art device of U.S. Pat. No. 7,342,648;

FIGS. 2A and 2B are high-level block diagrams of two imager/rangefinders of the present invention;

FIGS. 2C and 2D illustrate the angular sensitivity of the imager/rangefinder of FIG. 2A;

FIG. 3 is a schematic high-level diagram of an imaging sensor;

FIGS. 4A and 4B illustrate the definition of the field of view of the imaging sensor of FIG. 3;

FIG. 5 illustrates the operation of the imager/rangefinder of FIG. 2B;

FIG. 6 illustrates a drone helicopter of the present invention;

FIG. 7 illustrates a variant of the imaging sensor of FIG. 3 that is based on a standard color video camera;

FIG. 8 illustrates a Bayer filter.

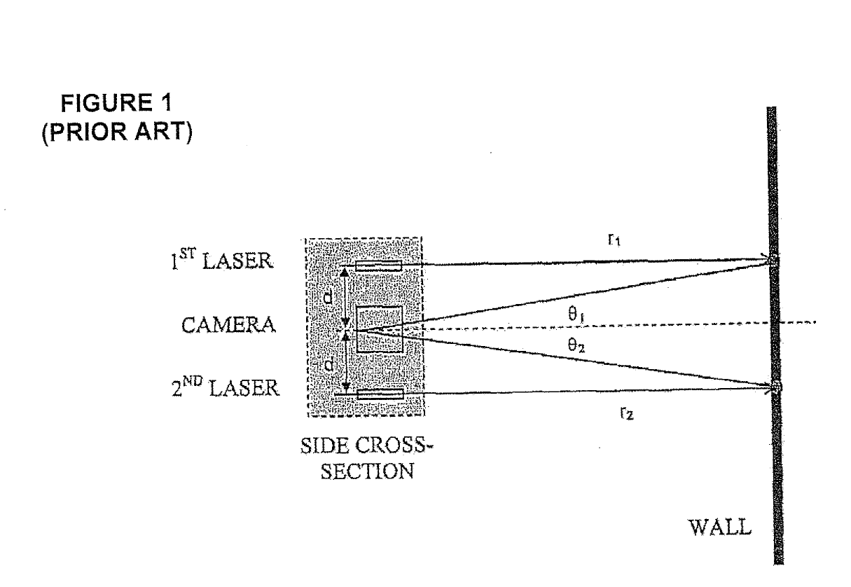

### DESCRIPTION OF THE PREFERRED EMBODIMENTS

The principles and operation of a combined imager and rangefinder according to the present invention may be better understood with reference to the drawings and the accompanying description.

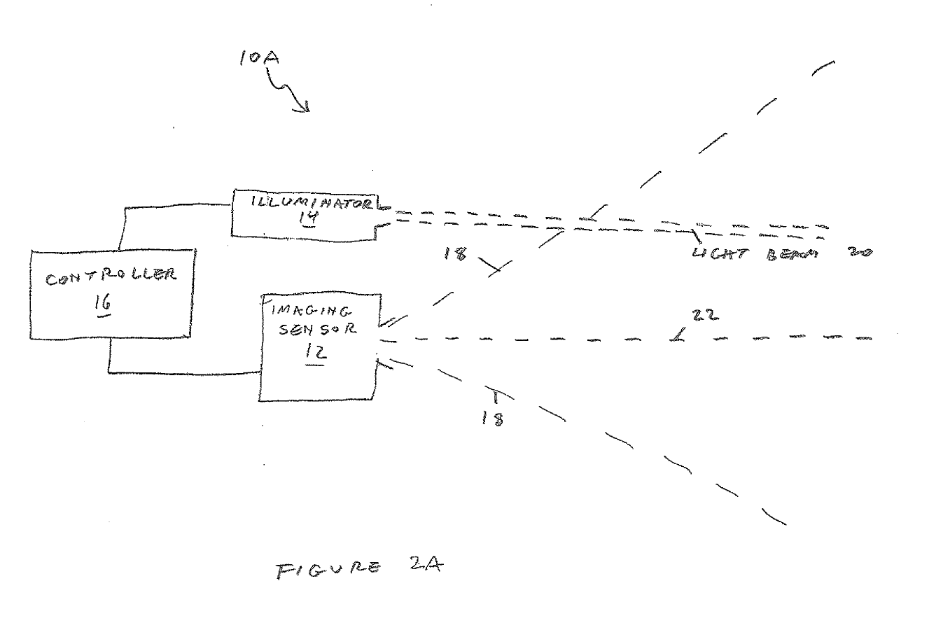

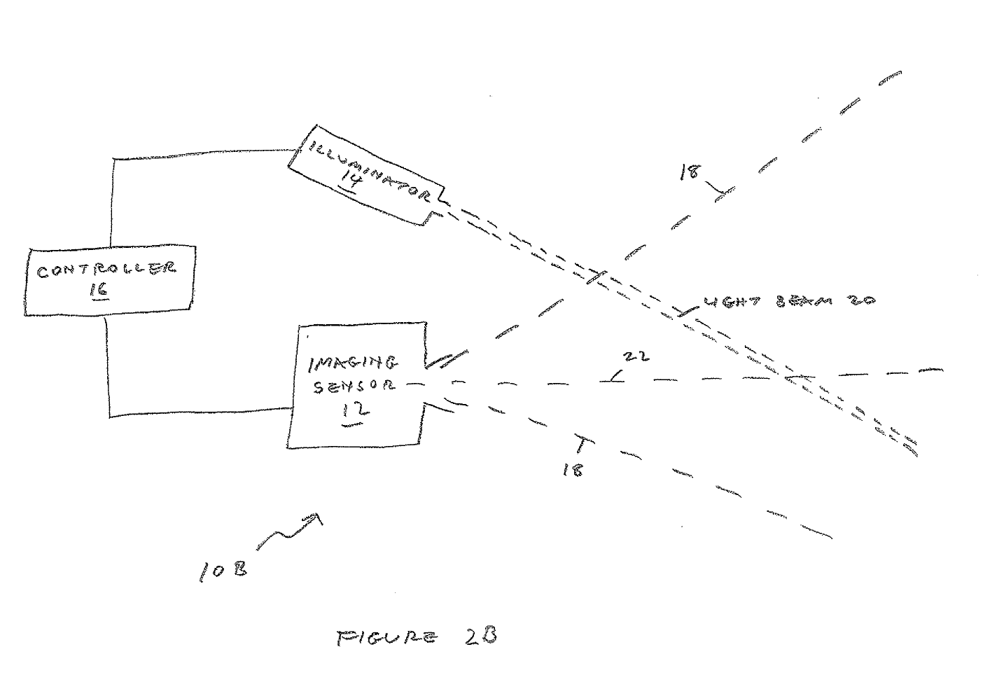

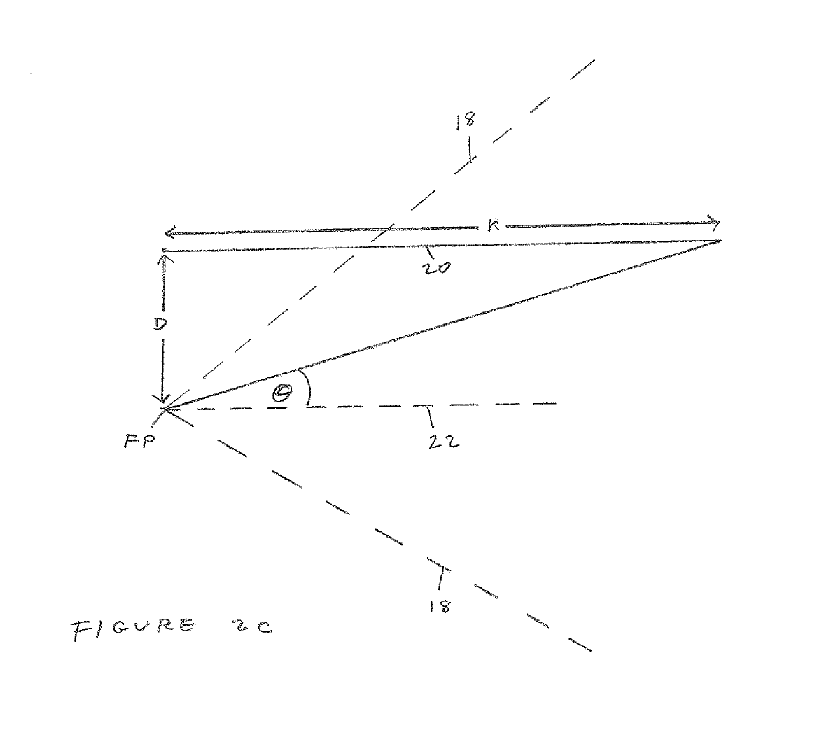

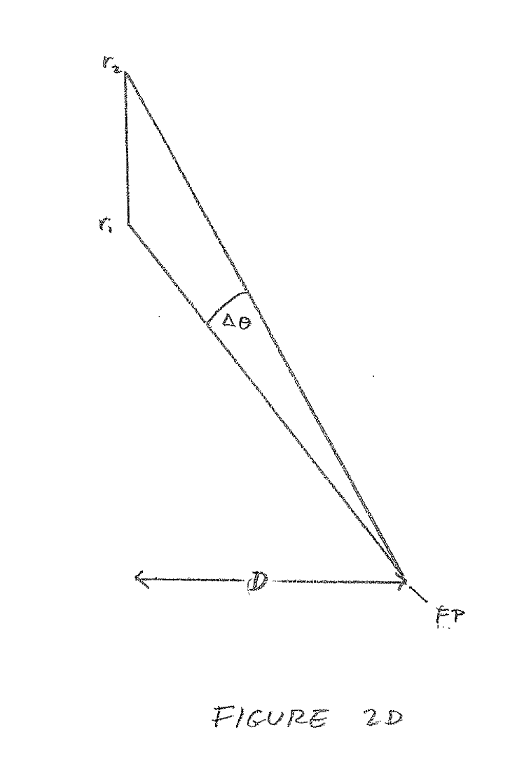

Referring again to the drawings, FIGS. 2A and 2B are high-level block diagrams of two combined imager/rangefinders 10A and 10B of the present invention. Both combined imager/rangefinders 10A and 10B include an imaging sensor 12, an illuminator 14, and a controller 16. Imaging sensor 12 typically is a camera such as a video camera, for imaging in the visible portion of the electromagnetic spectrum, or a forward looking infrared (FLIR) camera, for imaging in the infrared portion of the electromagnetic spectrum, e.g. in the near-infrared and mid-infrared (wavelengths between 0.8 microns and 12 microns) but preferably at wavelengths between three microns and five microns. Illuminator 14 typically is a laser but could also be a light-emitting diode with collimating optics. Imaging sensor 12 acquires images within a conical or pyramidal field of view whose boundaries are indicated by dashed lines 18. Illuminator 14 provides a collimated beam of light 20 that intersects the field of view of imaging sensor 12. Controller 16 coordinates the operation of imaging sensor 12 and illuminator 14 as described below to determine the range from combined imager/rangefinder 10A or 10B to an object within the field of view of imaging sensor 12. In combined imager/rangefinder 10A, illuminator 14 is fixed in place relative to imaging sensor 12 so that light beam 20 is parallel to the optical axis 22 of imaging sensor 12. In combined imager/rangefinder 10B, illuminator 14 is fixed in place relative to imaging sensor 12 so that light beam 20 crosses the field of view of imaging sensor 12 obliquely relative to the optical axis 22 of imaging sensor 12.

FIGS. 2C and 2D illustrate the geometry of the angular sensitivity of combined imager/rangefinder 10A, with the parallel optical axes of imaging sensor 12 and illuminator 14 separated by a distance D. “FP” denotes the focal point of imaging sensor 12.

In FIG. 2C, a reflection from an object at a range r from combined imager/rangefinder 10A is imaged at an angle θ whose relationship to r and D is cot(θ)=r/D. The angular sensitivity of combined imager/rangefinder 10A increases with decreasing r (as long as the object remains in the field of view of imaging sensor 12) because the magnitude of the slope of the function arccot(x) increases monotonically as x approaches zero from above.

FIG. 2D illustrates how the sensitivity of imager/rangefinder 10A to a change in range from r₂ to r₁ increases with increasing D. The angle Δθ subtended by the reflections from r₁ and r₂ is arctan(r₂/D)−arctan(r₁/D), whose derivative with respect to D is (r₂²−r₁²)/[(D²+r₂²)(D²+r₁²)] which is strictly positive.

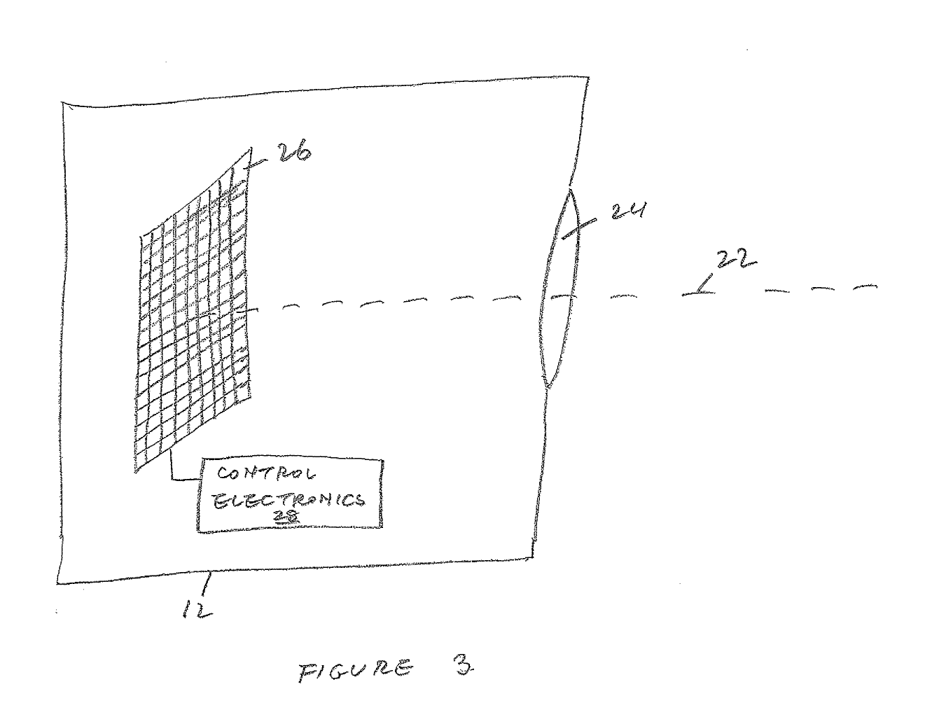

FIG. 3 is a schematic high-level diagram of imaging sensor 12. Imaging sensor 12 includes a rectangular array 26 of photodetector elements, optics 24, represented in FIG. 3 by a convex lens, that focus light from the field of view of imaging sensor 12 onto array 26, and control electronics 26 that uses array 26 to acquire images of the field of view of imaging sensor 12. Optical axis 22 is the optical axis of optics 24. The photodetector elements preferably are active pixel sensors such as complementary metal-oxide semiconductor (CMOS) detectors but could also be other kinds of photodetectors, for example, charge coupled detectors (CCDs) or photodiodes.

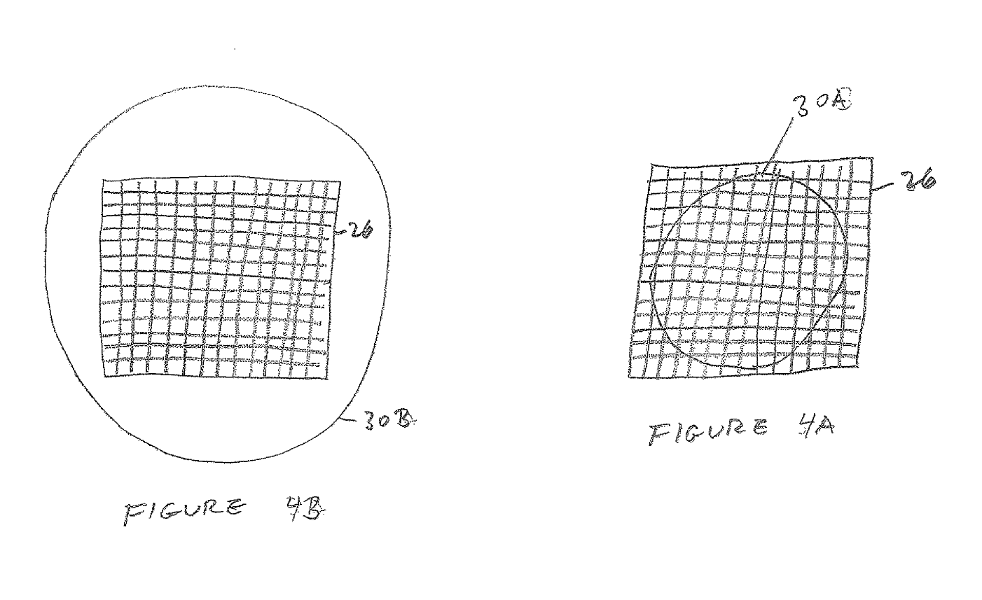

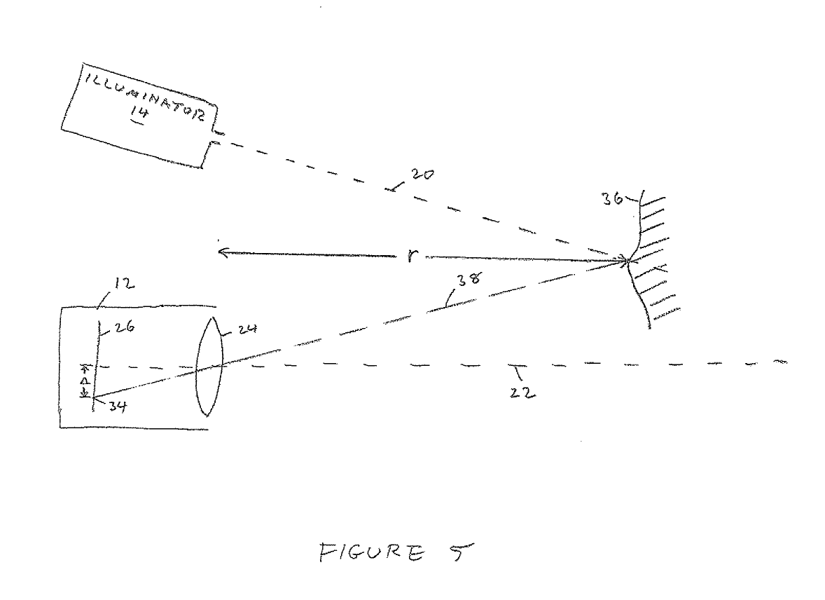

FIGS. 4A and 4B illustrate that the field of view of imaging sensor 12 is defined by optics 24 and array 26 in combination. In FIG. 4A, circle 30A indicates the portion of array 26 on which light from optics 24 is focused. The field of view of imaging sensor 12 then is a conical frustrum, extending indefinitely outward from the portion of array 26 that is bounded by circle 30A, whose axis of symmetry is optical axis 22. In FIG. 4B, the light from optics 24 is focused on a plane that includes array 26 and extends beyond array 26. The field of view of imaging sensor 12 then is a pyramidal frustrum, extending indefinitely outward from all of array 26, whose axis of symmetry is optical axis 22.

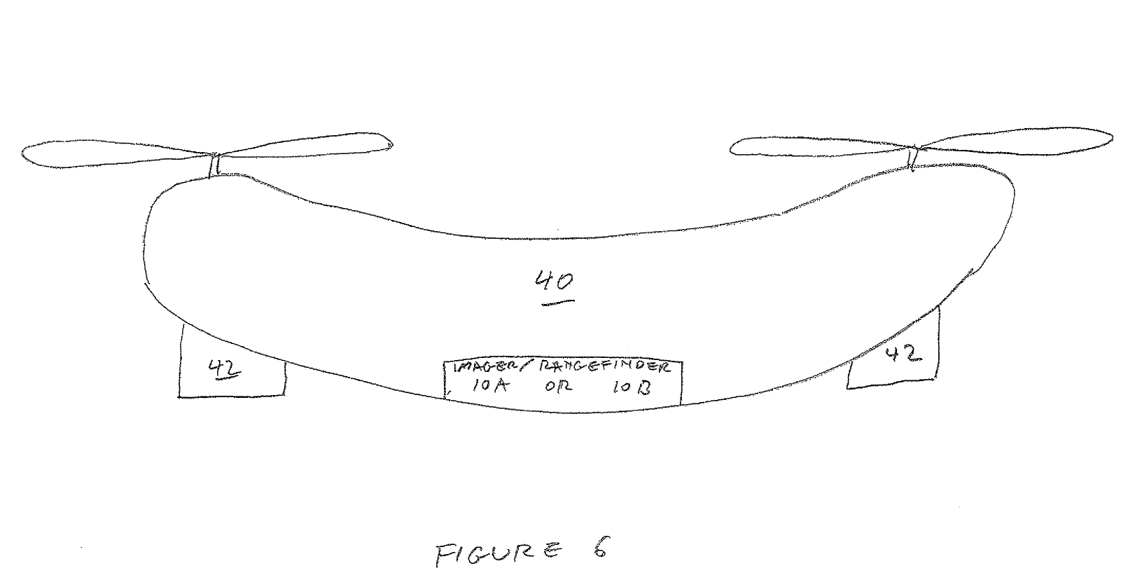

Imager/rangefinder 10A operates as a rangefinder substantially as described above for the device of U.S. Pat. No. 7,342,648. The operation of imager/rangefinder 10B as a rangefinder is similar and now will be described with reference to FIG. 5. Light 20 from illuminator 14 is reflected from an object 36 in the field of view of imaging sensor 12. The reflected light, represented in FIG. 5 as a reflected ray 38, is focused by optics 24 on a point 34 on array 26. The displacement A of point 34 along array 26 from optical axis 22 is a monotonic function of where along light beam 20 the reflection point is located and so indicates the range r from an arbitrary point in the imager/rangefinder to object 36. This function can be obtained in advance by tracing rays from various points on array 26 via optics 24 to light beam 20, or by calibrating imager/rangefinder 10B relative to objects 36 located at known ranges r from imager/rangefinder 10B. Note that imager/rangefinder 10A is a special case of imager/rangefinder 10B, the special case of light beam 20 being parallel to optical axis 22. Controller 16 identifies, in a frame acquired by imaging sensor 12, the pixel that images the reflected light, identifies the photodetector element at point 34 that corresponds to that pixel, and calculates or looks up in a table the corresponding range r. It can be shown that the angular sensitivity of imager/rangefinder 10B, as a function of range r, is similar to the angular sensitivity of imager/rangefinder 10A.

In practice, because of effects such as the finite width of light beam 20, the light reflected from object 36 is focused on several of the photodetector elements of array 26. Point 34 is determined from the centroid of the pixels of the frame that image reflected light 38.

One advantage of imager/rangefinder 10B over imager/rangefinder 10A is that imager/rangefinder 10B exploits more of the width of array 26 than imager/rangefinder 10A for imaging reflections of light beam 20. In imager/rangefinder 10A the reflections of light beam 20 are focused only to the side of photodetector array 26 adjacent to illuminator 14. In imager/rangefinder 10B the reflections of light beam 20 are focused on both sides of photodetector array 26. It follows that the estimation of the range r by imager/rangefinder 10B is inherently more accurate than the estimation of the range r by imager/rangefinder 10A. If light beam 20 is parallel to the opposite boundary 18 of the field of view of imaging sensor 12 then imaging rangefinder 10B exploits the full width of photodetector array 26. Imaging rangefinder 10B also is inherently capable of measuring closer ranges r than imaging rangefinder 10A. In fact, the accuracy of imaging rangefinder 10B at short ranges r can be increased by making the obliquity of illuminator 14 relative to optical axis 22 so great that light beam 20 crosses all the way across the field of view of imaging sensor 12, at the expense of losing the ability to measure long ranges r.

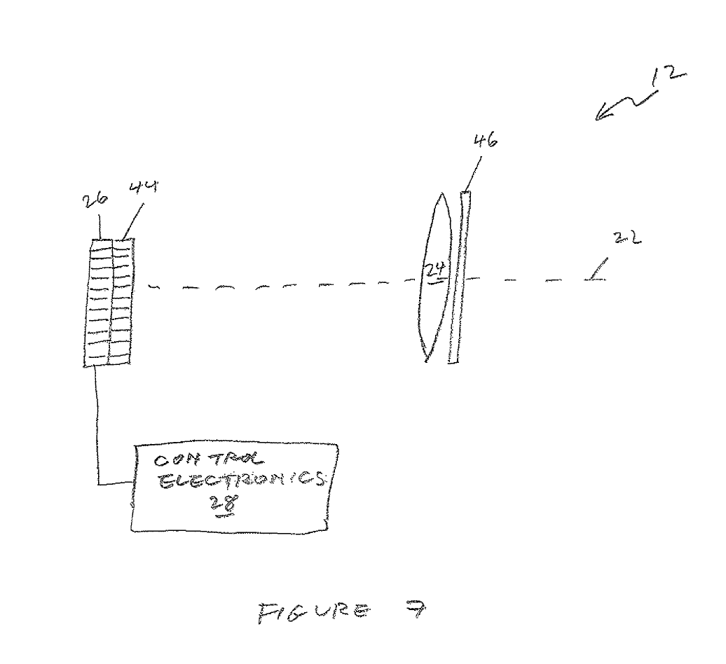

FIG. 6 shows a drone reconnaissance helicopter 40 equipped with imager/rangefinder 10A or 10B. In normal operation, imager/rangefinder 10A or 10B is used to acquire images of the terrain over which helicopter 40 flies. In this “normal” mode of operation, imager/rangefinder 10A or 10B acquires images of the full field of view of imaging sensor 12, under the control of controller 16, at the normal frame rate of imaging sensor 12, e.g., 30 to 50 Hz. Occasionally, controller 16 activates illuminator 14 for the duration of one frame. Controller 16 registers the full image of that frame with the full image of the preceding frame and then subtracts that image from the preceding image to obtain a difference image. The most prominent feature in the difference image is pixels that image light 38 that is reflected from the terrain. Controller 16 identifies these pixels and computes the altitude r of helicopter 40 above the terrain as described above. Illuminator 14 is activated only occasionally in case the reconnaissance target is suspected of having a sensor for detecting light beam 20 and initiating defensive or evasive action.

In alternative embodiments of the method of the present invention, a navigation device such as a GPS receiver is used in addition to or in place of imager/rangefinder 10A or 10B in “normal” mode to measure the altitude of helicopter 40 above the terrain.

If, during the “normal” mode of operation, controller 16 determines that the altitude of helicopter 40 above the targeted terrain is dangerously low, controller 16 switches to “emergency” mode. Helicopter 40 being dangerously low may indicate failure of the propulsive system of helicopter 40 so that a crash onto the targeted terrain is imminent. In “emergency” mode, controller 16 increases the frame rate of imaging sensor 12 to e.g. 250

Hz and instructs imaging sensor 12 to acquire partial images that include only pixels from only a portion of the photodetector elements of photodetector array 26, specifically, the rows that include the last photodetector elements to image reflected light 38 during “normal” mode plus a small number of guard rows in case point 34 has moved since the last altitude measurement. Alternatively, after several partial images have been acquired, the change with time, of which portion of the rows of photodetector array 26 images reflected light 38, from one partial image to the next, is used to decide which rows (plus, for safety, a small number of guard rows) are to be used to acquire the next partial image. The initial change with time on array 26 of which photodetectors image reflected light 38 also could be inferred from the change with time of which photodetectors image reflected light 38 towards the end of the “normal” mode of operation. In principle, the “emergency” mode could be effected using just one row of photodetectors to acquire each partial image but this is not a preferred mode of the present invention. That only a portion of the photodetector elements of array 26 are interrogated in “emergency” mode allows controller 16 to be based on the same processor that processes full images in “normal” mode despite the increased frame rate of “emergency” mode. In “emergency” mode, controller 16 activates illuminator 14 for the duration of every other frame, in order to take the difference of each pair of partial images and so compute the altitude of helicopter 40 at half the emergency frame rate and the rate of change of the altitude of helicopter 40 at one quarter of the emergency frame rate. If, based on the computed altitude and the computed rate of descent, controller 16 decides that a crash is imminent, controller 16 initiates defensive action to secure helicopter 42 against damage upon impact. For example, helicopter 40 could be equipped with an airbag protection system 42, similar to the airbag protection systems described in U.S. Pat. No. 5,992,794 to Rotman et al. and in U.S. Patent Application Publication No. 2010/0181421 to Albagli et al., as illustrated in FIG. 6.

As noted above, the functionality of imager/rangefinder 10A or 10B in detecting and coping with emergency situations as described above also could be implemented using a conventional imager and a separate conventional rangefinder. The advantage of an imager/rangefinder of the present invention is that it combines both functionalities in the same device, which is important in e.g. a small drone helicopter 40 in which space and weight are at a premium.

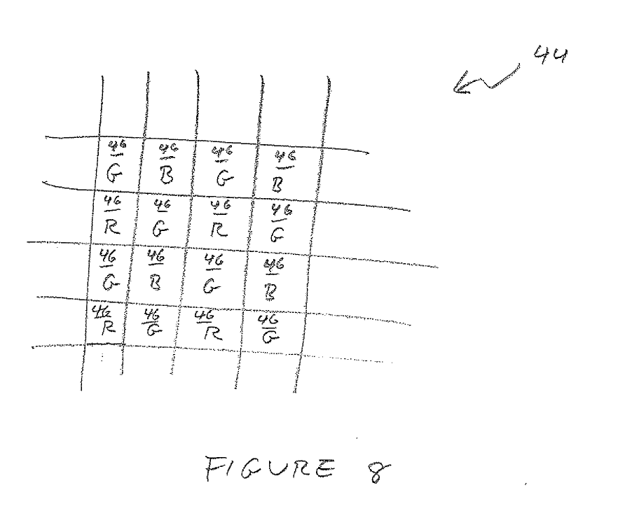

FIG. 7 is a side schematic view of a variant of imaging sensor 12 that is based on a standard color video camera and that is intended to be used together with an illuminator 14 that is an infrared laser. In such a video camera, photodetector element array 12 is covered by a filter 44, such as a Bayer filter, that passes only green light to one-half of the photodetector elements, only blue light to one-quarter of the photodetector elements, and only red light and infrared light to the remaining quarter of the photodetector elements. FIG. 8 shows how the sub-filters 48 of a standard Bayer filter are arranged. The sub-filters 48 labeled “B” pass only blue light. The sub-filters 48 labeled “G” pass only green light. The sub-filters 48 labeled R pass only red and infrared light. In a standard color video camera, a Bayer filter 44 is mounted so that there is a 1:1 correspondence between sub-filters 48 and the photodetector elements of array 12 and each sub-filter 48 filters only the light that is focused to its respective photodetector element.

A standard color video camera also includes another filter, associated with optics 24, for filtering out infrared radiation. Imaging sensor 12 of FIG. 7 includes a similar filter 46 that filters out most infrared, radiation but has a notch for passing a narrow band of infrared wavelengths, specifically, the band of wavelengths in infrared laser beam. 20 from the associated illuminator 14. In an imager/rangefinder 10A or 10B that includes such an imaging sensor 12 and such an illuminator 14, controller 16 does rangefinding based only on pixels that image the red and infrared light.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A combined imager and rangefinder comprising:
(a) an imaging sensor for acquiring images of objects in a field of view;
(b) an illuminator for directing a beam of light at least in part via said field of view; and
(c) a controller for:
(i) operating said imaging sensor and said illuminator in:
(A) a first mode in which said imaging sensor acquires full images that span substantially all of said field of view, and
(B) a second mode in which said imaging sensor acquires partial images that span only a portion of said field of view that includes a reflection of said light from one of said objects, and
(ii) determining, from a location, in each of at least a portion of said partial images, of a part of said each partial image that images said reflection, a corresponding range to said one object.

2. The combined imager and rangefinder of claim 1, wherein said imaging sensor acquires said full images at a first frame rate and acquires said partial images at a second frame rate that is faster than said first frame rate.

3. The combined imager and rangefinder of claim 1, wherein said controller also determines, from at least two said locations, a rate of approach to said one object.

4. The combined imager and rangefinder of claim 1, wherein said illuminator is deployed in a fixed spatial relationship to said imaging sensor.

5. The combined imager and rangefinder of claim 4, wherein said imaging sensor includes an optical axis and wherein said illuminator directs said beam of light substantially parallel to said optical axis.

6. The combined imager and rangefinder of claim 4, wherein said imaging sensor includes an optical axis and wherein said illuminator directs said beam of light obliquely relative to said optical axis.

7. The combined imager and rangefinder of claim 1, wherein said illuminator includes a source of coherent light.

8. The combined imager and rangefinder of claim 1, wherein said illuminator includes a source of incoherent light and optics for collimating said incoherent light to produce said beam of light.

9. The combined imager and rangefinder of claim 1, wherein, while operating said imaging sensor and said illuminator in said first mode, said controller determines, from a location, in each of at least a portion of said full images, of a part of said each full image that images said reflection, a corresponding range to said one object, and switches to operating in said second mode if said corresponding range is less than a predetermined threshold.

10. The combined imager and rangefinder of claim 1, wherein said imaging sensor includes a filter that includes a notch that passes a range of wavelengths of said light.

11. The combined imager and range finder of claim 1, wherein said imaging sensor includes an array of a plurality of photodetector elements.

12. The combined imager and range finder of claim 11, wherein said array is a rectangular array that includes a plurality of rows and wherein said partial images are acquired using only a portion of said rows.

13. The combined imager and range finder of claim 12, wherein said illuminator is deployed in a fixed spatial relationship to said imaging sensor so as to direct said beam of light only into a portion of said field of view wherein reflections of said light are imaged by said portion of said rows.

14. The combined imager and range finder of claim 12, wherein, for each said partial image subsequent to a first said partial image, said portion of said rows that is used to acquire said each partial image is selected in accordance with said part, of said portion of said rows that was used to acquire a preceding said partial image, that images said reflection.

15. The combined imager and range finder of claim 11, wherein said imaging sensor includes at least two subpluralities of said photodetector elements, said photodetector elements of each said subplurality being sensitive to only a respective range of wavelengths, and wherein said partial images are acquired using only at least a portion of said photodetector elements of one of said subpluralities.

16. The combined imager and range finder of claim 11, wherein said photodetector elements are active pixel sensors.

17. The combined imager and range finder of claim 1, wherein said part of said each partial image that images said reflection includes a plurality of pixels and wherein said location is a centroid of said plurality of pixels.

18. A vehicle comprising the combined imager and range finder of claim 1.

19. The vehicle of claim 18, wherein the vehicle is a helicopter.

20. A method of anticipating a collision between a first body and a second body, comprising the steps of:
(a) equipping the first body with an imaging sensor that has a field of view;
(b) acquiring, using said imaging sensor, successive partial images that span only a portion, of said field of view, that includes at least a portion of the second body while directing a beam of light at said at least portion of said second body;
(c) computing a plurality of first ranges, from the first body to the second body, based at least in part on respective locations within each of a plurality of said partial images, of a part of said each partial image that images a reflection of said light from said at least portion of the second body; and
(d) deciding, based on said first ranges, whether a collision between the first and second bodies is imminent.

21. The method of claim 20, further comprising the step of:
(e) if said collision is determined to be imminent, securing the first body to minimize damage to the first body caused by said collision.

22. The method of claim 20, further comprising the step of:
(e) prior to said acquiring of said partial images, determining a second range from the first body to the second body, said acquiring of said partial images being initiated if said second range is below a predetermined threshold.

23. The method of claim 22, wherein said determining of said second range includes acquiring, using said imaging sensor, successive full images that span substantially all of said field of view while directing said beam of light at least in part via said field of view in a manner that is synchronized with said acquiring of said full images so as to support computation of said second range based at least in part on a location within one of said full images of a part of said one full image that images a reflection of said light from the second body.

24. The method of claim 23, wherein said full images are acquired at a first frame rate and wherein said partial images are acquired at a second frame rate that is faster than said first frame rate.

25. The method of claim 23, wherein, during said acquiring of said full images, said beam of light is directed only intermittently via said field of view.

26. The method of claim 20, wherein said directing of said beam of light at said at least portion of said second body is synchronized with said acquiring of said partial images.
